(19) United States
(12) Patent Application Publication
(10) Pub. No.: US 2023/0134320 A1
(43) Pub. Date: May 4, 2023

(54) INFORMATION PROCESSING DEVICE, VEHICLE, AND INFORMATION PROCESSING METHOD

(71) Applicant: TOYOTA JIDOSHA KABUSHIKI KAISHA, Toyota-shi (JP)

(72) Inventor: Taiki MIZUTANI, Toyota-shi, (JP)

(21) Appl. No.: 18/050,158

(22) Filed: Oct. 27, 2022

(30) Foreign Application Priority Data
Nov. 4, 2021 (JP) 2021-180654

(51) Int. Cl. G06F 9/455

(52) U.S. Cl. CPC G06F 9/45558; G06F 2009/45591

(57) ABSTRACT

An information processing device includes: a memory; a processor coupled to the memory, the processor configured to implement a virtual machine management function to generate and execute plural virtual machines, and to implement an abnormality detection function for the plural virtual machines; a clock generator configured to supply a clock signal to both the virtual machine management function and the abnormality detection function; and an abnormality detector configured to detect an abnormality in the virtual machine management function by monitoring supply of the clock signal by the clock generator.

### CROSS-REFERENCE TO RELATED APPLICATION

This application is based on and claims priority under 35 USC 119 from Japanese Patent Application No. 2021-180654 filed on Nov. 4, 2021, the disclosure of which is incorporated by reference herein.

### BACKGROUND

### Technical Field

The present disclosure relates to an information processing device, a vehicle, and an information processing method for detecting abnormalities.

### Related Art

Japanese Patent Application Laid-Open (JP-A) No. 2020-135101 discloses technology in which fault detection in virtual machines is performed by detecting timeout of a watchdog timer. Specifically, in JP-A No. 2020-135101, a duplexed operation system is configured by plural general-purpose devices installed with plural virtual machines, and a virtual machine control device that controls duplexed operation by a dual system configured of an active system and a standby system of the virtual machines. In this duplexed operation system, a fault in a virtual machine is detected when a watchdog timer has timed out or the like.

In cases in which a watchdog timer that detects virtual machine abnormalities is provided as software, a hardware watchdog timer and the like is required in order to detect any abnormalities in this software watchdog timer (software WDT). In such cases, as illustrated in FIG. 6, either plural hardware watchdog timers (WDTs) 52 including a hardware WDT that monitors a hypervisor 50 that generates and executes virtual machines (VMs), or a hardware WDT that has plural interfaces, are required as abnormality detection sections. Moreover, timers 54 that respectively supply clock signals to the hypervisor 50 and a software WDT 56 are required corresponding to the abnormality detection sections, which affects cost.

### SUMMARY

In consideration of the above circumstances, the present disclosure provides an information processing device, a vehicle, and an information processing method that are capable of detecting any abnormalities in both a virtual machine and a virtual machine management section using a single abnormality detection section having a signal interface.

A first aspect of the present disclosure is an information processing device including a supply section and an abnormality detection section. The supply section is configured to supply a clock signal both to a virtual machine management section configured to generate and execute plural virtual machines and provide an abnormality detection function for the plural virtual machines, and to the abnormality detection function. The abnormality detection section is configured to detect an abnormality in the virtual machine management section by monitoring supply of the clock signal by the supply section.

In the first aspect, the virtual machine management section generates and executes the plural virtual machines and provides the abnormality detection function for the plural virtual machines. The supply section supplies the clock signal to both the virtual machine management section and the abnormality detection function. The virtual machine management section and the abnormality detection function are both driven in this manner.

The abnormality detection section detects any abnormalities in the virtual machine management section by monitoring the supply of the clock signal by the supply section. Since the clock signal is supplied to the abnormality detection function for the virtual machines and the virtual machine management section by the same supply section, if the clock signal cannot be supplied to the abnormality detection function for the virtual machines due to a fault, the clock signal cannot be supplied to the virtual machine management section either, and so the abnormality in the abnormality detection function for the virtual machines can also be detected by the abnormality detection section that monitors the virtual machine management section. This enables any abnormalities in both the virtual machines and the virtual machine management section to be detected by the single abnormality detection section that has a single interface.

Note that either: a watchdog timer of a timeout mode to output a reset signal in cases in which the clock signal is not input from the virtual machine management section within a predetermined duration; a watchdog timer of a window mode to output a reset signal in cases in which the clock signal is not input from the virtual machine management section within a predetermined duration or in cases in which plural clock signals are input within a predetermined duration; or a watchdog timer of a Q&A mode to output a reset signal in cases in which a predetermined signal is not input from the virtual machine management section may be applied as the abnormality detection section. This enables any abnormalities in both the virtual machine management section and the abnormality detection function for the virtual machines to be detected.

A second aspect of the present disclosure may be a vehicle installed with the information processing device of the first aspect.

A third aspect of the present disclosure may be an information processing method including: supplying a clock signal from a supply section to a virtual machine management section configured to generate and execute plural virtual machines and provide an abnormality detection function for the plural virtual machines; and an abnormality detection section detecting an abnormality in the virtual machine management section by monitoring supply of the clock signal by the supply section.

As described above, the present disclosure enables provision of the information processing device, the vehicle, and the information processing method that are capable of detecting any abnormalities in both the virtual machines and the virtual machine management section using the single abnormality detection section having a signal interface.

### BRIEF DESCRIPTION OF THE DRAWINGS

FIG. 1 is a diagram illustrating a vehicle installed with a central ECU according to an exemplary embodiment;

FIG. 2 is a block diagram illustrating a schematic configuration of a central ECU according to an exemplary embodiment;

FIG. 3 is a diagram for explaining a timeout mode;

FIG. 4 is a diagram for explaining a window mode;

FIG. 5 is a flowchart illustrating an example of a flow of processing performed by a WDT; and

FIG. 6 is a diagram illustrating a conventional example installed with plural hardware WDTs including a hardware WDT that monitors a hypervisor in order to detect any abnormalities in a software WDT.

### DETAILED DESCRIPTION

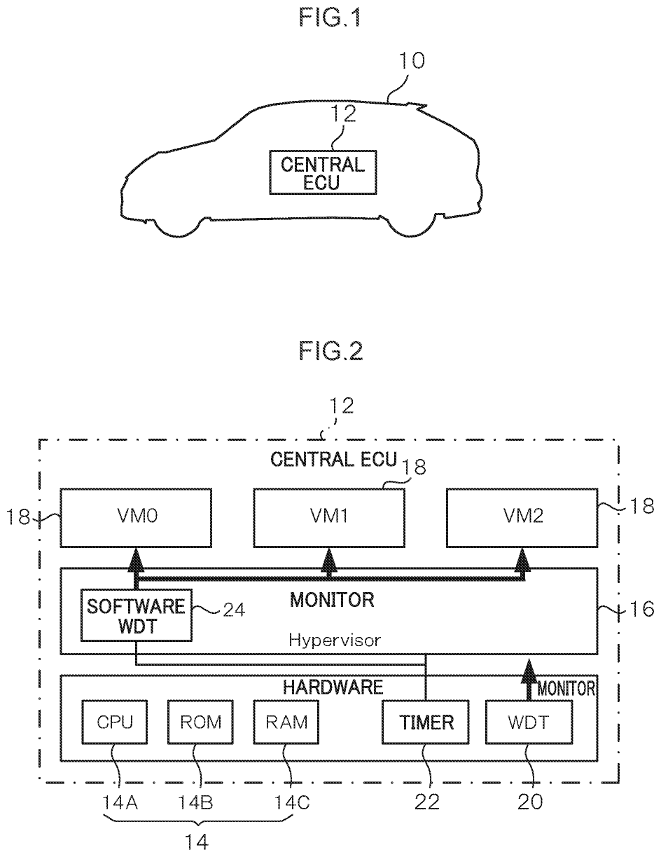

Detailed explanation follows regarding an example of an exemplary embodiment of the present disclosure, with reference to the drawings. In the exemplary embodiment, a central ECU installed to a vehicle is described as an example of an information processing device. In the exemplary embodiment, FIG. 1 is a diagram illustrating the vehicle installed with the central electronic control unit (ECU) according to the exemplary embodiment, and FIG. 2 is a block diagram illustrating a schematic configuration of the central ECU according to the exemplary embodiment.

A central ECU 12 according to the exemplary embodiment is installed to a vehicle 10 so as to perform consolidated control of various ECUs provided to the vehicle 10.

The central ECU 12 includes as hardware a computer configuration 14 configured of a central processing unit (CPU) 14A, read only memory (ROM) 14B, random access memory (RAM) 14C, and so on.

In the exemplary embodiment, a hypervisor 16 serves as a virtual machine management section that is software for virtualizing a computer. The hypervisor 16 virtualizes the physical CPU 14A so as to generate virtual machines (VMs) 18 serving as virtual machines, and controls execution of the VMs 18. In the exemplary embodiment, plural VMs 18 are generated by the hypervisor 16. FIG. 2 illustrates an example in which three VMs 18, these being VM0 to VM2, are generated as the plural VMs 18.

A software watchdog timer (WDT) 24 that provides a watchdog timer as software is implemented by the hypervisor 16 as an abnormality detection function. The software WDT 24 monitors the respective VMs 18 generated by the hypervisor 16, and detects any abnormalities in the respective VMs 18.

A timer 22 serving as an example of a supply section and a WDT 20 serving as an example of an abnormality detection section are also provided to the central ECU 12 as hardware.

The timer 22 supplies a clock signal to the hypervisor 16, and also supplies the clock signal to the software WDT 24. Namely, the timer 22 supplies the clock signal to drive both the hypervisor 16 and the software WDT 24.

The WDT 20 detects any abnormalities due to the computer configuration 14 stopping, running out of control, or the like by monitoring the clock signal supplied to the hypervisor 16 from the timer 22.

Explanation follows regarding abnormality detection methods by the software WDT 24 implemented by the hypervisor 16, and by the WDT 20 installed as hardware.

Any mode out of a timeout mode, a window mode, or a Q&A mode is applied as the abnormality detection method by the software WDT 24 and the WDT 20.

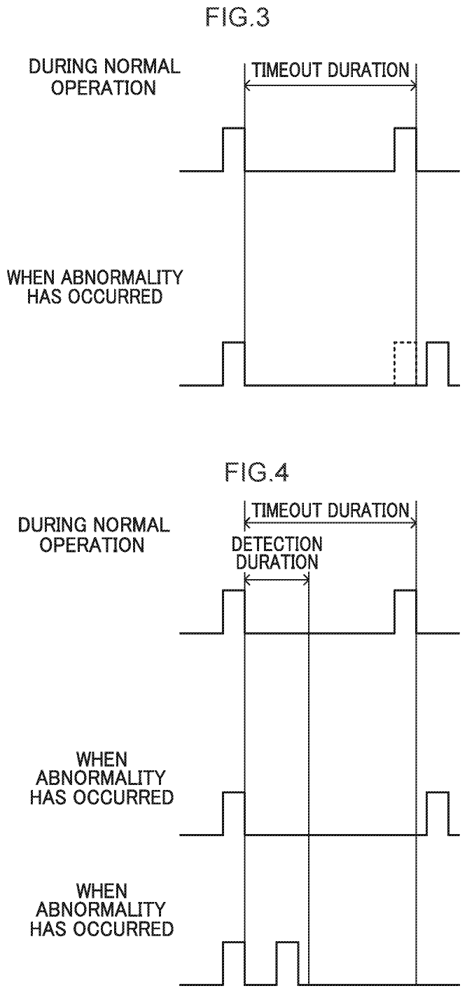

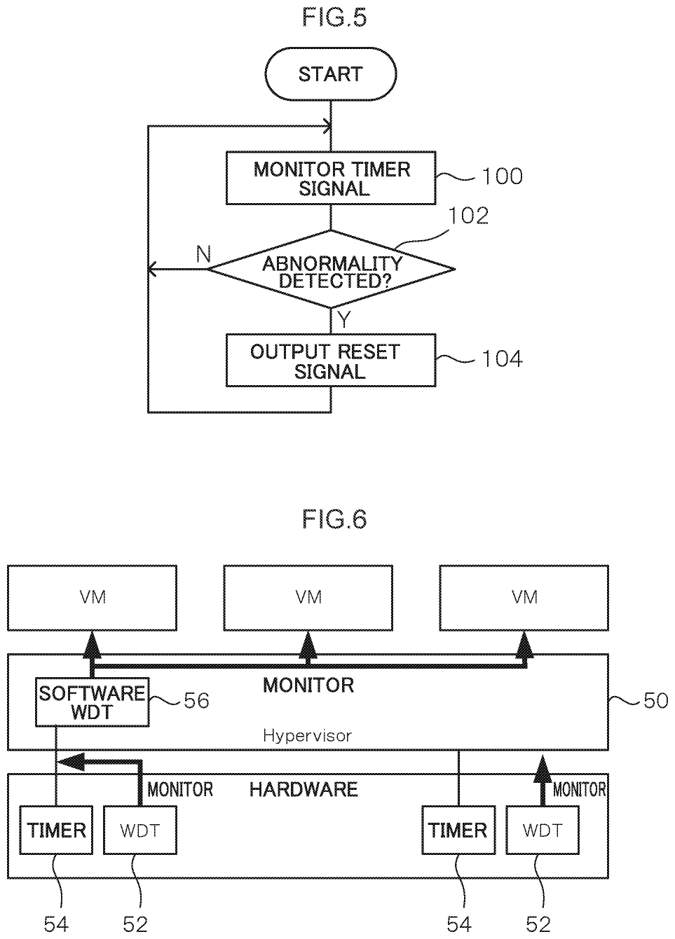

FIG. 3 is a diagram for explaining the timeout mode, and FIG. 4 is a diagram for explaining the window mode.

In the timeout mode, the software WDT 24 monitors signals such as a clock signal supplied to the respective VMs 18, and the WDT 20 monitors signals such as the clock signal supplied from the timer 22.

As illustrated in FIG. 3, the software WDT 24 and the WDT 20 each determine that operation is normal in cases in which generation of a signal is detected within a predetermined timeout duration since signal generation has been last detected. On the other hand, an abnormality is determined to have occurred and a reset signal is output in cases in which signal generation is not detected within the timeout duration since signal generation has been last detected.

Similarly, in the window mode, the software WDT 24 monitors signals such as the clock signal supplied to the respective VMs 18, and the WDT 20 monitors signals such as the clock signal supplied from the timer 22.

As illustrated in FIG. 4, similarly to in the timeout mode, the software WDT 24 and the WDT 20 each determine that operation is normal in cases in which generation of a signal is detected within a predetermined timeout duration since signal generation has been last detected. On the other hand, an abnormality is determined to have occurred and a reset signal is output in cases in which signal generation is not detected within the timeout duration since signal generation has been last detected. Moreover, in the window mode, an abnormality is also determined to have occurred and the reset signal is output in cases in which signal generation is again detected within a predetermined detection duration since signal generation has been last detected.

A brief explanation follows regarding specific processing performed by the software WDT 24 and the WDT 20 in cases in which the timeout mode or the window mode is applied. Explanation follows using the processing by the WDT 20 as a representative example. FIG. 5 is a flowchart illustrating an example of a flow of the processing performed by the WDT 20.

At step 100, the WDT 20 monitors the timer signal, and processing transitions to step 102. Namely, the signal supplied to both the hypervisor 16 and the software WDT 24 from the timer 22 is monitored.

At step 102, the WDT 20 determines whether or not an abnormality has been detected. Namely, when in the timeout mode, the WDT 20 determines whether or not a signal is undetected within the predetermined timeout duration since signal generation has been last detected. Alternatively, when in the window mode, the WDT 20 determines whether or not a signal has been detected within the predetermined detection duration, and whether or not a signal is undetected within the predetermined timeout duration, since signal generation has been last detected. In cases in which this determination is negative, processing returns to step 100 and the above-described processing is repeated. On the other hand, in cases in which determination is affirmative, processing transitions to step 104.

At step 104, the WDT 20 resets the computer configuration 14 by outputting the reset signal to the computer configuration 14, and ends the series of processing.

On the other hand, in the Q&A mode, configuration is such that predetermined data is input to the software WDT 24 and the WDT 20.

The software WDT 24 and the WDT 20 then determine whether or not input data matches the predefined data. Operation is determined to be normal in cases in which the data matches, whereas an abnormality is determined to have occurred and the reset signal is output in cases in which the data does not match.

Specifically, in cases in which the Q&A mode is applied to the software WDT 24, configuration is such that predetermined data such as “01000010”, serving as predetermined data for the respective VMs 18, is input to the software WDT 24. The software WDT 24 determines that operation is normal in cases in which data input from the respective VMs 18 is “01000010”. On the other hand, the software WDT 24 determines that an abnormality has occurred in cases in which different data is input, such as when the input data is “01000011”. The reset signal is then output to the corresponding VM 18 so as to reset this VM 18.

In cases in which the Q&A mode is applied to the WDT 20, configuration is such that predetermined data such as “01000010”, serving as the predetermined data for the hypervisor 16, is input to the WDT 20. The WDT 20 determines that operation is normal in cases in which data input from the hypervisor 16 is “01000010”. On the other hand, the WDT 20 determines that an abnormality has occurred in cases in which different data is input, such as when the input data is “01000011”. The reset signal is then output to the hypervisor 16 so as to reset the hypervisor 16.

Next, explanation follows regarding operation of the central ECU 12 according to the exemplary embodiment configured as described above.

In the central ECU 12 according to the exemplary embodiment, the plural VMs 18 are generated by the hypervisor 16, and operation of the respective VMs 18 is monitored by the software WDT 24.

In cases in which an abnormality has occurred in any of the VMs 18, this abnormality is detected by the software WDT 24, and the VM 18 where the abnormality occurred is reset. This enables a VM 18 that has stopped or run out of control to be detected, and this VM 18 to be rebooted.

Moreover, the hardware WDT 20 monitors the clock signal supplied to the hypervisor 16 from the timer 22. In cases in which an abnormality has occurred in the hypervisor 16, this abnormality is detected by the WDT 20 and the hypervisor 16 is reset. This enables detection of when the hypervisor 16 has stopped or run out of control, and the hypervisor 16 to be rebooted.

Moreover, in the exemplary embodiment, since the clock signal is supplied to the software WDT 24 and the hypervisor 16 from the same timer 22, if the clock signal cannot be supplied to the software WDT 24 due to a fault, the clock signal cannot be supplied to the hypervisor 16 either, and so the abnormality in the software WDT 24 may also be detected by the hardware WDT 20 that monitors the hypervisor 16. Thus, abnormalities in both the VMs 18 and the hypervisor 16 may be detected by the single hardware WDT 20 that has a single interface.

Note that although an example has been described in which the software WDT 24 is provided to the hypervisor 16 in the above exemplary embodiment, there is no limitation thereto. For example, a format may be applied in which a software WDT 24 is provided to each of the VMs 18.

Furthermore, the present disclosure is not limited to the above configuration, and obviously various other modifications may be implemented within a range not departing from the spirit of the present disclosure.

What is claimed is:

1. An information processing device comprising:
a memory;
a processor coupled to the memory, the processor configured to implement a virtual machine management function to generate and execute a plurality of virtual machines, and to implement an abnormality detection function for the plurality of virtual machines;
a clock generator configured to supply a clock signal to both the virtual machine management function and the abnormality detection function; and
an abnormality detector configured to detect an abnormality in the virtual machine management function by monitoring supply of the clock signal by the clock generator.

2. The information processing device of claim 1, wherein the abnormality detector comprises:
a watchdog timer of a timeout mode to output a reset signal in a case in which the clock signal is not input from the virtual machine management section within a predetermined duration;
a watchdog timer of a window mode to output a reset signal in a case in which the clock signal is not input from the virtual machine management section within a predetermined duration or in a case in which a plurality of clock signals are input within a predetermined duration; or
a watchdog timer of a Q&A mode to output a reset signal in a case in which a predetermined signal is not input from the virtual machine management section.

3. A vehicle installed with the information processing device of claim 1.

4. An information processing method comprising:
supplying, by a clock generator, a clock signal both to a virtual machine management section configured to generate and execute a plurality of virtual machines and provide an abnormality detection function for the plurality of virtual machines, and to the abnormality detection function; and
detecting, by an abnormality detector, an abnormality in the virtual machine management section by monitoring supply of the clock signal by the clock generator.
